(19) United States
(12) Patent Application Publication
(10) Pub. No.: US 2012/0028524 A1
(43) Pub. Date: Feb. 2, 2012

(54) DUCT TAPE WITH FOAM FILM BACKING LAYER

(75) Inventors: Richard L. Peloquin, Maplewood, MN (US); Prince P. Antony, London (CA)

(73) Assignee: 3M Innovative Properties Company

(21) Appl. No.: 12/848,509

(22) Filed: Aug. 2, 2010

(51) Int. Cl. C09J 7/04; B29C 49/04

(52) U.S. Cl. 442/1; 156/244.11

(57) ABSTRACT

An adhesive tape includes a backing comprising a foam core layer having opposed first and second major surfaces and pair of water impermeable layers arranged on opposite sides of the foam core layer, a scrim arranged on the backing, and adhesive arranged on the backing and scrim. A method of making such a tape is also disclosed.

### BACKGROUND

The present invention relates generally to adhesive tape and, more particularly, to hand-tearable reinforced tape including those commonly referred to as duct tape.

Duct tape is a common and widely used type of adhesive tape. Duct tape typically comprises a polymer film backing, a scrim, and an aggressive pressure sensitive adhesive that is coated over the scrim and the backing. The scrim provides the tape with a desired level of strength and allows the tape to be torn by hand.

Reinforced adhesive tapes are known in the prior art. U.S. Pat. No. 4,740,416 (DeCoste, Jr., et al.), for example, discloses an adhesive tape consisting essentially of, in order, a layer comprising glass or resin microspheres dispersed in a polymeric matrix, a cloth scrim or reinforcing fabric, and a layer of adhesive, preferably a pressure-sensitive adhesive. U.S. Pat. No. 5,108,815 (Adams, et al.) discloses duct tapes comprising a water-impermeable sheet backing carrying, in order, a cloth material and an adhesive layer, wherein the backing is embossed in order to lower the density and thereby render a duct tape of a given thickness more cost-effective. U.S. Pat. No. 6,372,342 (Karaoglu) discloses a water-impermeable sheet backing carrying, in order, a cloth material and an adhesive layer, wherein the backing is a coextruded laminate which, in the preferred case, incorporates a release agent in the lamina on the surface opposite the adhesive.

### SUMMARY

The industry is always seeking improved ways to lower the cost of duct tapes while still maintaining performance. The present invention provides a duct tape that is less costly to produce and has desirable performance characteristics.

In one embodiment, the present invention provides an adhesive tape, such as duct tape, including a backing layer comprising a foam core layer having first and second opposed major surfaces and pair of barrier layers arranged on opposite sides of the foam core layer, a scrim arranged on the backing, and adhesive arranged on the backing and scrim. In one aspect, the foam core layer may be a blown foam film formed using chemical blowing agents. The foam core layer may be formed by a continuous blown film extrusion process. In another aspect, the foam core layer may be formed using heat expandable polymeric microspheres. The barrier layers may be provided on the foam core layer before the foam core layer is formed, simultaneously with the formation of the foam core layer, or after the foam core layer is formed.

In more specific aspects, the backing first and second major surfaces may have a surface roughness of at least about 2.5 microns, the backing may have a density of less than about 0.65 g/cc, at least one of the barrier layers may be water impermeable, at least one of the barrier layers may include a release agent, the backing may have a tensile strength of less than about 10 lbs/in, the backing layer may be formed of foamed polyolefin, the backing may be formed of LDPE, the core layer and barrier layers may be formed of the same material, and/or the core layer and barrier layers may be formed of different materials. In another aspect, the tape may be provided in roll form, and the roll of tape may have an unwind force of less than about 110 oz/in.

In another aspect, the scrim may be formed of a polymeric material. In a specific embodiment, the scrim may be formed of polyester. In yet another aspect, the adhesive may be a rubber based pressure-sensitive adhesive. In a specific embodiment, the adhesive may be an acrylic based pressure-sensitive adhesive.

In another aspect, the present invention provides a method of making duct tape comprising the steps of simultaneously forming a foam film backing layer comprising a foam core layer having first and second opposed major surfaces and pair of barrier layers arranged on opposite sides of the foam core layer by a continuous blown film extrusion process using chemical blowing agents, providing a reinforcing scrim along one of the barrier layers, and providing a pressure-sensitive adhesive along the scrim.

Advantages of certain embodiments of the invention may include that it has performance characteristics and properties similar to, or better than, those of conventional duct tapes, that it can be produced using more efficient and less costly processes, and can be produced using less material. In addition, the duct tape produced has a textured surface that imparts more desirable unwind characteristics than that of conventional duct tapes.

### BRIEF DESCRIPTION OF THE DRAWINGS

The present invention will be further described with reference to the accompanying drawings, in which:

FIG. 1 is a cross-sectional view of a reinforced adhesive tape according to the invention.

FIG. 2 is a detailed cross-sectional view of the backing of the reinforced adhesive tape shown in FIG. 1.

### DETAILED DESCRIPTION

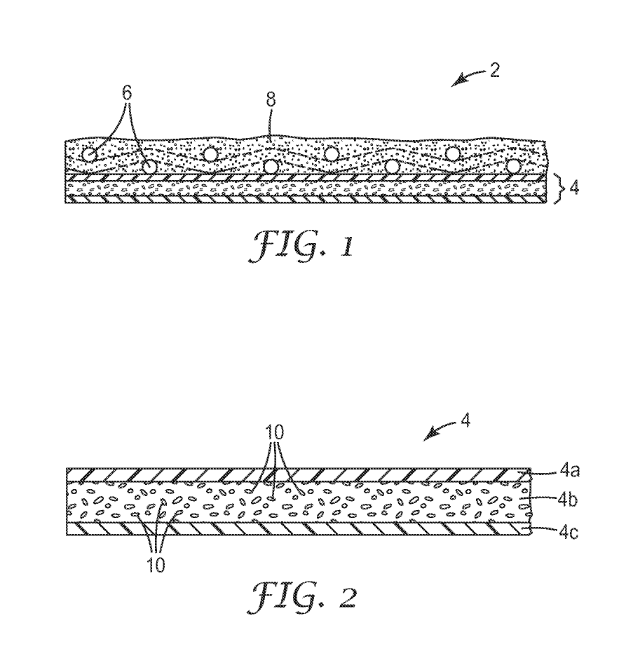

Referring now to the drawings, FIG. 1 shows a reinforced adhesive tape 2 comprising a backing layer 4, a reinforcing material or scrim 6, and a layer of adhesive 8. The backing layer 4, scrim 6, and adhesive 8 are each described in greater detail below.

In accordance with one aspect of the adhesive tape 2, the backing layer 4 comprises a blown foam film. Referring to FIG. 2, the blown foam backing layer 4 includes three layers: a first outer barrier layer 4a, a foam core layer 4b containing voids or cells 10, and a second outer barrier layer 4c. In one embodiment, wherein the adhesive tape 2 is duct tape, at least one of the first and second outer barrier layers 4a, 4c of the backing layer 4 is water impermeable. Because the core layer 4b is foamed, the amount of material required to make a backing layer 4 of a given thickness is reduced, thereby reducing the cost of the raw materials needed to make the backing layer 4. In addition, the foam core layer 4b imparts a micro-textured surface on the exposed non-adhesive surface of the backing layer 4. The micro-textured surface reduces the unwind force of the tape, thereby making it easier to unwind a segment of tape from a roll of tape, or allowing the use of higher tack pressure sensitive adhesive compositions in the tape construction.

Suitable materials for use in making the backing layer 4 include polyolefins such as polyethylene including low density polyethylene, high density polyethylene, and linear low density polyethylene, polypropylene, polybutylene, polyisoprene, and their copolymers. The first outer barrier layer 4a, the foam core layer 4b, and the second outer barrier layer 4c may be formed from the same material or from different materials. For manufacturing efficiency, it may be desirable to form the entire backing layer 4 (i.e. the first outer barrier layer 4a, the foam core layer 4b, and the second outer barrier layer 4c) from the same material.

In one embodiment, the backing layer 4 has an overall thickness of at least about 1 mil, at least about 3 mils, or at least about 5 mils, and has a thickness of no greater than about 13 mils, no greater than about 11 mils, or no greater than about 9 mils. The foam core layer 4b generally comprises at least about 60%, at least about 70%, or at least about 75% of the backing layer 4 thickness, and no greater than about 95%, no greater than about 90%, or no greater than about 85% of the backing layer thickness.

The first and second outer barrier layers 4a, 4c combined generally comprise no greater than about 20%, no greater than about 15%, or no greater than about 12% of the backing layer 4 thickness. Such thicknesses of the foam core layer 4b, and respective barrier layers 4a, 4c allow the cells 10 contained in the foam core layer 4b to create the micro-textured surface on the exposed outer surfaces of the first and/or second outer barrier layers 4a, 4c.

The cells 10 contained in the foam core layer 4b generally have an average cell width of at least about 100 microns, at least about 200 microns, or at least about 400 microns, and an average cell width of no greater than about 2 millimeters, no greater than about 1.5 millimeters, or no greater than about 1 millimeter. The cells 10 generally have an average cell length of at least about 400 microns, at least about 600 microns, or at least about 800 microns, and an average cell length of no greater than about 4 millimeters, no greater than about 3.5 millimeters, or no greater than about 3 millimeters.

By selecting the appropriate materials, by controlling the thickness of the outer barrier layers 4a, 4c, by controlling the size of the cells 10 in the foam core layer 4b, and by controlling process conditions during the formation of the backing layer 4, backing layers having desirable surface textures may be produced. That is, conventional duct tape constructions have a generally flat or smooth surface with the scrim imparting a limited degree of surface topography to the tape. The multilayer blown foam film backing layer 4 of the present disclosure, in contrast, has an enhanced degree of surface topography, and has generally uniform surface roughness that is imparted to the outer surface of the tape (i.e. the surface opposite the adhesive) by the cells 10 contained in the foam core layer 4b. In this manner, when the adhesive tape 2 is wound onto itself to form a roll, the surface texture reduces the amount of force required to remove a segment of tape from the roll (i.e. the surface texture reduces the “unwind force” of the tape), thereby reducing the unwind force for a given pressure sensitive adhesive, or allowing higher tack pressure sensitive adhesives to be used for a given unwind force.

In one aspect, the surface of the backing layer 4 opposite the adhesive layer 8 has an average surface roughness (Rₐ), as measured using a three-dimensional laser profilometer, of at least about 2.5 microns, at least about 3 microns, or at least about 3.5 microns. In another aspect, the surface of the backing layer 4 opposite the adhesive layer 8 has an average maximum height profile (i.e. peak to valley, R_{z}), also measured using a three-dimensional laser profilometer, of at least about 16 microns, at least about 17 microns, at least about 18 microns, or at least about 19 microns. In another embodiment, the tape 2 is wound onto itself to form a roll of tape, and the roll of tape has a maximum unwind force of less than about 110 ounces/inch (oz/in), less than about 100 oz/in, less than about 95 oz/in, less than about 90 oz/in, or less than about 85 oz/in.

The foam core layer 4b reduces the density of the backing layer 4, thereby reducing the amount of material needed to make the backing layer 4 for a given thickness. Thus, if the manufacturing cost to make the backing layer 4 is comparable to the cost of making a backing layer having the same thickness, the overall cost of producing the backing will be lower than the overall cost of making a comparable non-foamed backing layer because less material is used. In one embodiment, the backing layer 4 has a density of less than about 0.80 grams per cubic centimeter (g/cc), less than about 0.75 g/cc, or less than about 0.65 g/cc.

In one aspect, the backing layer 4 is a blown foam film composition formed using chemical blowing agents that generate gas that forms the cells 10 contained in the core foam layer 4b of the backing layer 4. Suitable blowing agents include metal bicarbonates, such as sodium bicarbonate. In another aspect, the backing layer is produced by a continuous blown film extrusion process. Blown film extrusion processes are known. U.S. Patent Publication 2008/0281010 (Lefas et. al.), for example, discloses a continuous blown film extrusion process using chemical blowing agents.

In another aspect, the foam core layer 4b may be formed using heat expandable polymeric microspheres. Heat expandable polymeric microspheres are microspheres that include a polymer shell that encapsulates a low boiling point liquid. Upon application of heat, the microspheres expand to form a low density foam in systems that incorporate the microspheres. Suitable heat expandable polymeric microspheres include DUALITE expanding polymer microspheres available from Henkel Corporation, Greenville, S.C., and Expancel microspheres available from Eka Chemicals, Inc. Expancel, Duluth, Ga. To form a complete backing layer 4, first and second outer barrier layers 4a, 4c are provided on the opposed major surfaces of the foam core layer 4b. The outer barrier layers 4a, 4c may be laminated to the foam core layer 4b prior to, or after, the core layer 4b is foamed, or the outer barrier layers 4a, 4c may be coextruded and formed simultaneously with the formation of the foam core layer 4b.

The backing layer 4 may contain other optional additives and ingredients as is known in the art including, for example, fillers, pigments and other colorants, antiblocking agents, lubricants, plasticizers, processing aids, antistatic agents, nucleating agents, antioxidants and heat stabilizing agents, ultraviolet-light stabilizing agents, and other property modifiers.

In one embodiment, the second outer barrier layer 4c includes a release agent. Release agents are often provided on the back surface (i.e. the surface opposite the adhesive surface) of an adhesive tape (e.g., duct tape) to allow the tape to be provided in roll form, and to allow the tape to be readily and conveniently dispensed by unwinding the roll. The particular release agent is not significant to the invention hereof, so long as it provides the desired function of allowing the adhesive tape 2 to be provided in roll form, and allowing the adhesive tape to be readily and conveniently dispensed by unwinding the roll. The release agent may be provided as a coating on the exposed surface of the second outer barrier layer 4c opposite the core foam layer 4b, or the release agent may be incorporated into the resin that forms the second outer barrier layer 4c. It will be recognized that release agents incorporated into the resin tend to migrate to the surface of the surface of the second outer barrier layer 4c, thereby forming a release coating on the exposed outer surface of the backing 4. Suitable release agents and techniques for incorporating release agents into a release layer are described in U.S. Pat. No. 7,229,687 (Kinning, et al.), the entire contents of which are hereby incorporated by reference.

Backing layers 4 having properties meeting the criteria described herein are available from Balcan Plastics, Ltd. Montreal, Canada, and Blako Industries, Inc. Dunbridge, Ohio.

The adhesive tape 2 includes a reinforcing material or scrim 6 arranged on the backing layer 4. The particular scrim 6 selected is not significant to the invention hereof, so long as it provides the desired function of imparting the desired amount of strength to the tape, and allowing the tape to be readily hand tearable in at least the cross-web direction. The scrim 6 may be, for example, an open mesh or cloth, a nonwoven fabric or mesh, or a woven cloth material. A variety of materials may be used to make the scrim 6 including natural materials, synthetic materials, and combinations thereof. Examples of natural materials include cotton, silk, hemp, flax, and combinations thereof. Examples of synthetic materials include polyester, acetate, acrylic, polyolefin (e.g., polyethylene and polypropylene), rayon, and nylon. Suitable scrims are described in, for example, U.S. Pat. No. 5,162,150 (Buis, et al.), U.S. Pat. No. 6,211,099 (Hutto, Jr.), U.S. Pat. No. 7,056,844 (Sheely), and U.S. Patent Publication 2009/0155565 (Ulsh). In one exemplary embodiment of the present disclosure, the scrim 6 is a 37×10 threads per inch (cross web by down web), 100×150 denier (cross web by down web), polyester partially oriented yarn (POY) scrim available from American Fiber and Finishing, Inc., Newberry S.C.

In the illustrated embodiment, the adhesive tape 2 includes a layer of adhesive 8 arranged on the first barrier layer 4a of the backing layer 4, and covering the scrim 6. The particular adhesive 8 selected is not significant to the invention hereof, so long as it possesses the desired adhesive characteristics. A variety of adhesives may be used, including pressure-sensitive adhesives typically used in duct tape constructions.

Exemplary pressure-sensitive adhesives may include repositionable, removable and permanent adhesives. Representative examples of pressure-sensitive adhesives useful in tapes of the present disclosure include those based on natural rubbers, synthetic rubbers, or acrylics. More particularly, the pressure-sensitive adhesives contemplated for use may be selected from a group consisting of organic solvent based acrylics, waterborne acrylics, silicone adhesives, natural rubber based adhesives, and thermoplastic resin based adhesives.

In specific embodiments, the pressure sensitive adhesive 8 is coated by hot melt coating to the surface of the backing layer 4 over the scrim 6 at a coating weight of at least about 40 grains/24 sq. inches (168 grams/m²), at least about 50 grains/24 sq. inches (209 grams/m²), or at least about 60 grains/24 sq. inches (251 grams/m²), and at a coating weight of no greater than 85 grains/24 sq. inches, (357 grams/m²), no greater than 75 grains/24 sq. inches (315 grams/m²), or no greater than 70 grains/24 sq. inches (294 grams/m²).

Typically, the backing layer 4 and scrim 6 are brought into contact with one another and the pressure sensitive adhesive 8 is coated over the scrim 6 and backing layer 4. Alternatively, the scrim 6 may be pre-bonded to the backing layer 4, for example, using an adhesive or by heat laminating the scrim 6 to the backing layer 4. Suitable coating techniques for applying the pressure sensitive adhesive are well known to those of skill in the art and include, for example, calendaring (e.g., stripper roll calendaring), spraying, and die coating (e.g., slot die, drop die, or rotary rod die). In one embodiment, the pressure sensitive adhesive is applied as a 100% solids formulation that is heated to provide a coatable viscosity, for example, by contacting one or more heated rolls prior to being applied to the backing.

One suitable natural rubber based pressure sensitive adhesive comprises, by weight, about 29% natural rubber (CV-60), about 37% filler (SNOWHITE-12 from L.V. Lomas Ltd., Ontario Canada), about 32% tackifier (PICCOTAC B from Hercules, Inc., Wilmington, Del.), about 0.6% antioxidant (IRGANOX 1010 from Ciba Specialty Chemical, Inc.), about 1.2% whitener (TiO₂), and about 0.1% neutralizing mask (CE-12873 from Custom Essence Inc., Summerset N.J.).

Another useful class of pressure-sensitive adhesives are those comprising synthetic rubber. Such adhesives are generally rubbery elastomers, which are either self-tacky or non-tacky and require tackifiers. Self-tacky synthetic rubber pressure-sensitive adhesives include for example, butyl rubber, a copolymer of isobutylene with less than 3 percent isoprene, polyisobutylene, a homopolymer of isoprene, polybutadiene, such as “TAKTENE 220 BAYER” or styrene/butadiene rubber. Butyl rubber pressure-sensitive adhesives often contain an antioxidant such as zinc dibutyl dithiocarbamate. Polyisobutylene pressure-sensitive adhesives do not usually contain antioxidants. Synthetic rubber pressure-sensitive adhesives, which generally require tackifiers, are also generally easier to melt process. They comprise polybutadiene or styrene/butadiene rubber, from 10 parts to 200 parts of a tackifier, and generally from 0.5 to 2.0 parts per 100 parts rubber of an antioxidant such as “IRGANOX 1010.” An example of a synthetic rubber is “AMERIPOL 1011A”, a styrene/butadiene rubber available from BF Goodrich.

Tackifiers that are useful include derivatives of rosins such as “FORAL 85”, a stabilized rosin ester available from Hercules, Inc., the “SNOWTACK” series of gum rosins available from Tenneco, and the “MWV” series of tall oil rosins available from Meadwestvaco, Richmond, Va.; and synthetic hydrocarbon resins such as the “PICCOLYTE A” series, polyterpenes from Hercules, Inc., the “ESCOREZ 1300” series of C₅ aliphatic olefin-derived resins, the “ESCOREZ 2000” series of C₉ aromatic/aliphatic olefin-derived resins, and polyaromatic C₉ resins, such as the “PICCO 5000” series of aromatic hydrocarbon resins, from Hercules, Inc.

Other materials that may be added to the above-described pressure sensitive adhesives to impart a desired property include, for example, fillers, pigments, plasticizers, oils, antioxidants, UV stabilizers, whitener (e.g., TiO₂), neutralizing mask (e.g., CE-12873 from Custom Essence Inc., Summerset N.J.) to cover odor, and curing agents to partially cure or vulcanize the pressure-sensitive adhesive.

In order that the invention described herein can be more fully understood, the following examples are set forth. It should be understood that these examples are for illustrative purposes only, and are not to be construed as limiting this invention in any manner.

### EXAMPLES

### Test Methods

The physical properties of the blown foam films and pressure sensitive adhesive (PSA) tape samples prepared having the blown foam films as backing layers were measured using the following test methods. All tests were carried out at room temperature (23.0±2.0° C.).

### Cell Size

Cell Size refers to the average of the widest width (b) and widest length (a) of the foam cells. Foam cell size measurements were carried out using a video capture microscope at 1.5× magnification with a 0.005 inch stage micrometer. The average cell size was obtained from five individual measurements per film sample.

### Cell Area

Cell Area was calculated based on the formula for the area of an ellipse (Area=ab/4, where a=widest length of the ellipse and b=widest width of the ellipse) using the average number of five widest length (a) and five widest width (b) measurements.

### Film Density

Film Density was calculated by dividing the film weight by the film caliper and the film area. The film caliper was measured using an Ono Sokki EG-225 digital caliper gauge available from Ono Sokki Co., Ltd. The film weight was measured by weighing a 4 inch by 6 inch (10.2 centimeter by 15.2 centimeter) film sample using a conventional digital mass balance.

### Tensile Strength

Tensile Strength is a measure of energy to break (measured at break point) and is a characteristic of film toughness. It is the area under the stress-strain curve. Tensile strength values are obtained during film elongation. Measurements were obtained using an INSTRON Model 5544 test machine (available from Instron Corporation, Norwood, Mass.) at 73.4±3.6° F. (23.0±2.0° C.) according to ASTM D3759/D3759M-05.

### Elongation

Elongation is a measure of film deformation or ductility (measured at break point). Measurements were obtained using an INSTRON Model 5544 test machine at 73.4±3.6° F. (23.0±2.0° C.) according to ASTM D3759/D3759M-05. The gauge length and separation speed were set according to the film elongation range as follows:
a. For films having less than 20% elongation, a 5 inch (12.7 cm) gauge length and a separation rate of 5 inches per minute (12.7 cm/min) was used.
b. For films having an elongation between 20% and 100%, a 4 inch (10.2 cm) gauge length and a separation rate of 12 inches per minute (30.5 cm/min) was used.
c. For films having an elongation greater than 100%, a 2 inch (5.1 cm) gauge length and a separation rate of 20 inches per minute (50.8 cm/min) was used.

### Surface Roughness

Surface roughness of the blown foam film backing layer was measured using a three-dimensional (3-D) laser profilometer with Laser Surface Profiler 3.7 software. The average surface roughness (Rₐ), the maximum height of profile between peak & valley (Rₜ), and the average maximum height of the profile or mean roughness (R_{z}), were calculated using Mountains Map Topography XT 4.1 software. Higher values correspond to higher surface roughness.

### 180 Degree Peel Adhesion to Steel

The peel adhesion test used was similar to the test method described in ASTM D 3330-90. Adhesive tapes were cut into 1 inch by 6 inch (2.5 centimeter by 15.2 centimeter) strips. Each strip was then adhered to a stainless steel substrate using double coated adhesive tape and the sample was rolled down using a 2-kilogram roller passed once over the strip. The bonded assembly was maintained at room temperature for about one minute and was then tested for 180 degree peel adhesion using an INSTRON Model 5544 tensile test machine at 73.4±3.6° F. (23.0±2.0° C.). Three tape samples were tested. The reported peel adhesion value is an average of the peel adhesion value from each of the three tape samples.

### Unwind Force

The unwind force test used was similar to the test methods described in PSTC-8 and ASTM D3811/D3811M-96 (2006). Rolls of tape (50.8 millimeter wide) were mounted in an unwind fixture affixed to an INSTRON Model 5544 test machine. One unwind measurement was taken from each roll. Three rolls of tape were evaluated for each blown foam film tape construction. Therefore, the reported values are the average of three measurements. The unwind forces for the PSA tape rolls were measured at an unwind rate of 12 inches/minute (0.3 meters/minute).

### Examples 1-4 and Comparative Example C1

The blown foam films (BFF) used as backings in the preparation of the PSA tape articles in the Examples were three layer blown polyethylene films that were prepared using a continuous blown film extrusion process as is known in the art. The films had a first outer barrier layer:foam core layer:second outer barrier layer ratio of 10:80:10. The first outer barrier layer was formed from linear low density polyethylene (LLDPE) containing 3 weight percent of an antiblocking agent. The second outer barrier layer was formed from linear low density polyethylene (LLDPE) containing 2 weight percent of a release agent. The foam core layer was formed from low density polyethylene (LDPE) containing 4 weight percent carbon black and a chemical foaming agent. The physical properties of the blown foam films and a control film were measured as described above. The control film was a three layer blown film having a similar construction to the blown foam films except that the core layer was not foamed. The physical properties of the film backing layer are summarized in Table 1.

TABLE 1

| | | Cell Size | Cell | | Tensile |
|---|---|---|---|---|---|
| | Caliper | (b × a) | Area | Density | Strength |
| Film sample | (mm) | (mm) | (mm²) | (g/cc) | (lb/in) |
| Control Film | 0.088 | — | — | 0.84 | 11.4 |
| BFF 1 | 0.173 | 0.432 × 0.837 | 0.284 | 0.62 | 9.9 |
| BFF 2 | 0.187 | 0.800 × 2.912 | 1.864 | 0.49 | 8.3 |
| BFF 3 | 0.158 | 0.505 × 1.588 | 0.637 | 0.62 | 9.6 |
| BFF 4 | 0.178 | 0.591 × 1.630 | 0.760 | 0.55 | 8.7 |

PSA tape samples were prepared having constructions like that shown in FIG. 1. The films used as backing layers were the blown foam films and control film described in Table 1. The PSA was a natural rubber based formulation comprising 23% grade TSR CV-60 natural rubber elastomer, which is commercially available from a variety of sources, 4% Kraton D-1119 synthetic rubber elastomer (Kraton Polymers, Belpre Ohio, 46714, USA), 35% Piccotac 1098 hydrocarbon resin (Eastman Chemical Resins, West Elizabeth Pa., 15088-0567, USA), 3% Nyflex 222B oil (Nynas USA Inc., Mississauga Ontario, L5B 2TA, Canada), 0.5% titanium dioxide (Kronos Inc., Houston Tex., 77060-4272, USA), 0.5% Irganox 1010 (BASF Chemical Company, USA) and 34% calcium carbonate (OMYA Inc., Perth Ontario, K7H 3E4, Canada). The scrim was a 100% polyester fiber scrim in a multi-filament configuration with fiber counts 37 times 10 (100×150 denier) available from Milliken Chemical, Spartanburg, S.C. To prepare the tape samples, the backing layer and the scrim were brought into contact with one another with the scrim contacting the first outer barrier layer of the backing layer. The PSA was then hot melt coated over the scrim and backing layer at the coating weights indicated in Table 3. Surface roughness measurements were obtained for the blown foam film tape backing layers by taking the measurements on the surface of the backing layer opposite the PSA. The surface roughness data is summarized in Table 2.

TABLE 2

| PSA Tape | Ra | Rt | Rz |
|---|---|---|---|
| Sample | (μm) | (μm) | (μm) |
| Comparative | 2.19 | 20.6 | 15.2 |
| Example C1 | | | |
| Example 1 | 4.11 | 36.2 | 23.7 |
| Example 2 | 3.39 | 33.6 | 19.7 |
| Example 3 | 3.50 | 36.3 | 19.9 |
| Example 4 | 3.92 | 38.6 | 22.5 |

It is noted that the control film backing layer, although not foamed, does impart a surface roughness; however, the surface roughness was less than that measured for the blown foam films. Tape unwind and 180 degree peel adhesion to steel tests were carried out for Examples 1-4 and Comparative Example C1 using the test methods described above. The test results are shown in Table 3.

TABLE 3

| | | | Tape | 180° | Max. Tape |
|---|---|---|---|---|---|
| | Film | PSA Coating | Tensile | Peel | Unwind |
| PSA Tape | Backing | Wt | Strength | Adhesion | Force |
| Sample | Layer | (grains/24 in²) | (lb/in) | (oz/in) | (oz/in) |
| Comparative | Control | 90 | 46.5 | 137 | 118 |
| Example C1 | Film | | | | |
| Example 1 | BFF1 | 65 | 48.4 | 109 | 83 |
| Example 2 | BFF2 | 65 | 47.6 | 74 | 45 |
| Example 3 | BFF3 | 65 | 48.8 | 79 | 60 |
| Example 4 | BFF4 | 65 | 49.8 | 82 | 65 |

The tape testing suggested that the increased surface roughness of the film surface of the tape resulted in reduced tape unwind force. In addition, a reduction in 180 degree peel adhesion to steel was observed. It is plausible to attribute the reduced tape unwind force and reduction in 180 degree peel adhesion to steel to the increased surface roughness of the PSA surface that is imparted by the micro-textured surface of the tape.

Persons of ordinary skill in the art may appreciate that various changes and modifications may be made to the invention described above without deviating from the inventive concept. Thus, the scope of the present invention should not be limited to the embodiments described in this application, but only by the features described by the language of the claims and the equivalents of those features.

What is claimed is:

1. An adhesive tape, comprising:
(a) a backing layer comprising a foam core layer having first and second opposed major surfaces, and pair of barrier layers arranged on opposite sides of the foam core layer;
(b) a scrim arranged on the backing; and
(c) adhesive arranged on the backing and scrim.

2. An adhesive tape as defined in claim 1, wherein the foam core layer is a blown foam film formed using chemical blowing agents.

3. An adhesive tape as defined in claim 1, wherein the foam core layer is formed by a continuous blown film extrusion process.

4. An adhesive tape as defined in claim 1, wherein at least one of the backing first and second major surfaces has a surface roughness of at least about 2.5 microns.

5. An adhesive tape as defined in claim 1, wherein the backing has a density of less than about 0.65 g/cc.

6. An adhesive tape as defined in claim 1, wherein at least one of the barrier layers is water impermeable.

7. An adhesive tape as defined in claim 1, wherein at least one of the barrier layers includes a release agent.

8. An adhesive tape as defined in claim 1, wherein the backing has a tensile strength of less than about 10 lbs/in.

9. An adhesive tape as defined in claim 1, wherein the backing is formed of foamed polyolefin.

10. An adhesive tape as defined in claim 1, wherein the backing is formed of LDPE.

11. An adhesive tape as defined in claim 1, wherein the core layer and barrier layers are formed of the same material.

12. An adhesive tape as defined in claim 1, wherein the core layer and barrier layers are formed of different materials.

13. An adhesive tape as defined in claim 1, wherein the tape is provided in the form of a roll, and the roll of tape has an unwind force of less than about 110 oz/in.

14. An adhesive tape as defined in claim 1, wherein the scrim is a polymeric material.

15. An adhesive tape as defined in claim 1, wherein the scrim is formed of polyester.

16. An adhesive tape as defined in claim 1, wherein the adhesive is a rubber based pressure-sensitive adhesive.

17. An adhesive tape as defined in claim 1, wherein the adhesive is an acrylic based pressure-sensitive adhesive.

18. A method of making duct tape, comprising the steps of:
(a) simultaneously forming a foam film backing layer comprising a foam core layer having first and second opposed major surfaces, and pair of barrier layers arranged on opposite sides of the foam core layer using a continuous blown film extrusion process using chemical blowing agents;
(b) providing a reinforcing scrim along one of the barrier layers; and
(c) providing a pressure-sensitive adhesive along the scrim.
